(19) United States
(12) Patent Application Publication
(10) Pub. No.: US 2026/0243958 A1
(43) Pub. Date: Aug. 20, 2026

(54) Silicon photonic based single-stage polarization aligner with reset function

(71) Applicants: YANGJING WEN, San Jose, CA (US); HONGBING LEI, San Jose, CA (US); Jiawei Liu, San Jose, CA (US)

(72) Inventors: YANGJING WEN, San Jose, CA (US); HONGBING LEI, San Jose, CA (US); Jiawei Liu, San Jose, CA (US)

(21) Appl. No.: 19/057,908

(22) Filed: Feb. 19, 2025

(51) Int. Cl. G02B 6/126

(52) U.S. Cl. CPC G02B 6/126

(57) ABSTRACT

A method and system for polarization alignment are disclosed. The system receives input light with undefined polarization, splitting it into two components. One component is rotated to match the polarization of the other before its phase is tuned using a phase tuner, typically implemented as a heater. The two components are recombined using a 2x2 optical coupler, yielding two output light paths; portions of these outputs are tapped and monitored by optical photodetectors. The optical signals are then amplified, digitized, and forwarded to a control unit that executes an alignment algorithm to calculate and apply the appropriate heater current. When the heater current nears a predetermined limit, the control unit resets it to a designated mid-phase value, introducing a 2Nπ phase jump to preserve proper phase tuning without disrupting transmitting, which is scheduled during designated no-traffic time slots.

### BACKGROUND OF THE INVENTION

The present invention is related to polarization tracking which aligns the polarization of an incoming light to that of pre-defined polarization.

Centralizing light sources has been a promising solution for applications like front-haul cloud radio access networks (C-RAN), passive optical networks (PON), and in-vehicle optical networks (IVON), where laser light sources are centrally located, managed and temperature controlled, and distributed to gateways or optical network units (ONU) for data modulation. Therefore, no temperature control is needed at ONUs or gateways, which are connected to front-haul towers in C-RAN or zonal electrical control units (ECU) in in-vehicle optical networks, respectively. Each ECU is connected to various sensors, like camera, RADAR, LiDAR, etc., for higher levels of autonomous driving.

For optical modulators located at ONUs or gateways, their polarization orientation should be aligned with that of incoming light to maximize the data modulation efficiency and minimize the insertion loss. If the distance between the laser source and modulator is short, polarization maintaining fiber (PMF) may be used, like in Coherent Optical Subassembly (COSA) application. For the scenarios where the distances between centralized laser sources and modulators are over several meters, like in-vehicle optical networks, using PMF becomes too costly and more difficult to operate. Using a polarization aligner before the modulator in ONU or gateway can replace PMF with standard single mode fiber (SMF) while automatically aligning the polarization states between incoming light and that of modulator. When the polarization state of incoming light from SMF varies or drifts, the polarization aligner's control parameter, like heater current for phase tuning, needs to be adjusted continuously without interruption. The current single-stage polarization aligner may easily hit the pre-determined limit of hardware and fail the tracking. An endless polarization aligner can track polarization while confining its control parameters within limit, but needs multi-stages and multiple control parameters. This would significantly increase the device insertion loss and reduce the tracking speed.

Maintaining polarization alignment can be challenging due to environmental variations and inherent component instabilities that affect optical paths. Over time, various adaptive control strategies have emerged to address these shifts, often incorporating techniques that stabilize operational parameters and counteract drift. In parallel, thermal control methods such as heater current regulation have been applied to facilitate the operation with low insertion loss. These developments collectively underscore the ongoing pursuit of reliable and efficient approaches to maintain precise polarization control under dynamic conditions.

### SUMMARY OF THE INVENTION

In one aspect, a method for aligning the polarization of an input light is provided. The method involves receiving a light with undefined polarization, splitting it into a first light and a second light, and rotating the second light so its polarization matches that of the first light. In one aspect, the method further includes tuning the phase of the rotated second light with a phase tuner and combining the first and second lights to produce first and second output lights. In one aspect, a portion of the first output light is tapped to a first monitoring photodetector while a portion of the second output light is tapped to a second monitoring photodetector, with the signals from these detectors being received by a control unit. In one aspect, the control unit calculates a heater current based on the detector outputs and applies this current to the phase tuner, resetting the heater current to a designated value during selected time slots when it approaches a predetermined limit.

In another aspect, a polarization aligning system includes a polarization splitter and rotator (PSR), connected to an incoming single mode fiber; a phase tuner, connected to the PSR; a 2×2 optical coupler, with the first input port connected to PSR and second input port connected to the phase tuner; a first optical tap (tap1), connected to the optical coupler, and majority portion output port becomes the first output port of polarization aligner; a second optical tap (tap2), connected to the optical coupler, and the majority portion output port becomes the second output port of polarization aligner. The system includes a first monitoring photodetector (mPD1), connected to tap1; a second monitor photodetector (mPD2) connected to tap2; and a control unit which: is connected to mPD1 and mPD2 to receive electrical signals, connected to the phase tuner to apply current, where the phase tuner may be a heater, an algorithm operation function for polarization aligning and a reset function to reset the heater current to a designated value in selected time slots when the current is close to pre-determined limit.

In yet another aspect, a method for polarization alignment includes receiving an input light with undefined polarization; splitting the input light into a first light and a second light, with the second light being rotated to have the same polarization as the first light; tuning the phase of the second light; combing the first light and second light and outputting a first output light and second output light; tapping a small portion of first output light to mPD1; tapping a small portion of second output light to mPD2; and providing a control unit to receive the output of mPD1 and the output of mPD2, to carry out the algorithm for polarization aligning, to generate a calculated heater current and apply to the phase tuner, and to reset the heater current to a new designated value in selected time slots when it is close to the pre-determined limit.

In a further aspect, a polarization alignment system is provided that includes a polarization splitter and rotator configured to receive an input light with undefined polarization and split it into a first light and a second light. In one aspect, a phase tuner is connected to the polarization splitter and rotator and is configured to tune a phase of the second light. In one aspect, a 2×2 optical coupler is connected to both the polarization splitter and rotator and the phase tuner and is configured to combine the first light and the second light to output a first output light and a second output light. In one aspect, a first optical tap is connected to the optical coupler to tap a portion of the first output light, and a second optical tap is connected to the optical coupler to tap a portion of the second output light. In one aspect, a first monitoring photodetector is connected to the first optical tap and a second monitoring photodetector is connected to the second optical tap. In one aspect, a control unit is connected to the monitoring photodetectors and the phase tuner and is configured to receive electrical signals from the monitoring photodetectors, execute an algorithm for polarization alignment, calculate and apply a current to the phase tuner, and reset the current to a designated value in selected time slots when the current is close to a pre-determined limit.

Advantages of one implementation may include one or more of the following:

Improved Polarization Matching—The use of a polarization splitter and rotator to align two separated light paths minimizes polarization misalignments, thereby enhancing overall signal fidelity and reducing losses caused by mismatched polarization states.

Enhanced Phase Stability—By incorporating a phase tuner whose operation is actively adjusted based on feedback from monitoring photodetectors, the system can precisely control the phase of the rotated light. This tuning capability contributes to consistent performance over time and in varying environmental conditions.

Temperature and Drift Compensation—The method of calculating a heater current based on detector outputs—and selectively resetting the heater current when it nears predetermined limits—ensures that temperature-induced variations are minimized. This active thermal management supports longer-term stability of the optical components and polarization alignment.

Adaptive Control Strategy—The integration of a control unit executing an algorithm for polarization alignment allows for real-time adjustments to both polarization and phase. This adaptability ensures optimal performance in dynamic conditions where environmental or component-specific variations may otherwise degrade system performance.

Improved Signal Integrity—By splitting and then carefully recombining the light, the system minimizes phase noise and other signal integrity issues, ultimately leading to better overall communication or sensing performance in optical systems.

Versatility in Implementation—The described system configuration, which includes a 2×2 optical coupler and multiple monitoring points, allows for flexible integration into various optical communication and sensing architectures, enhancing overall system robustness.

These advantages collectively contribute to a polarization alignment system that is both reliable and efficient in maintaining optimal optical performance under dynamic conditions.

### BRIEF DESCRIPTION OF DRAWINGS

FIG. 1, An embodiment of an SiPh based polarization aligner with reset function.

FIG. 2 shows an exemplary flow chart of the proposed polarization aligner with reset function.

FIG. 3 shows an embodiment of a polarization aligner with reset function together with Mach-Zehnder modulator.

FIG. 4 shows another embodiment of a polarization aligner with reset function together with Mach-Zehnder modulator

FIG. 5 shows flowchart with steps for processing input light using phase tuning and heater current reset methods.

FIG. 6 shows the algorithm verification test result.

### DETAILED DESCRIPTION OF THE INVENTION

A system is disclosed for polarization aligning, which converts a light with random polarization into two output lights with the same pre-defined polarization and equal optical power levels. The system uses a single-stage and single control parameter and can operate polarization aligning continuously without hitting the pre-determined limit of hardware by the control parameter. The polarization tracking aligns the polarization of an incoming light to that of pre-defined polarization, such as that of an optical modulator.

The system uses single-stage polarization tracking with reset function for polarization aligning. The reset process is carried out during the time slots when there is no transmitting traffic being allocated. The reset is triggered when the heater current is close to the pre-determined limit, where its value is reset to a new value close to the middle phase current of operation range. This invention does not need multiple stage polarization tracking, which reduces the device insertion loss and increases tracking speed. One implementation involves optical chip design, control algorithms, and implementation. The active areas of the polarization aligner and modulator can be based on silicon, III-V semiconductor, or other types of material which uses different types of effect, including thermal effect, for phase tuning.

The design uses silicon photonics (SiPh) based polarization aligner, where the aligner is integrated together with the modulator on the same optical chip. In the polarization aligner, a polarization splitter and rotator (PSR) are used to split an incoming light into two lights, while a heater is used to tune the phase difference between the two lights which are then combined by an optical coupler to generate two output lights. A reset unit is provided in the control circuit. For in-vehicle optical communications, dynamic bandwidth allocation is used among different ONUs or gateways, so there is no traffic for some time slots for a given ONU or gateway. These time slots are used to reset the control parameter, which is the heater current. When the heater current is close to the pre-determined limit, it is reset to a new value close to the middle phase current of the operation range. A 2Nπ phase jump (between the two arms) is introduced where N is a positive integer and will make the tracking with smooth transition

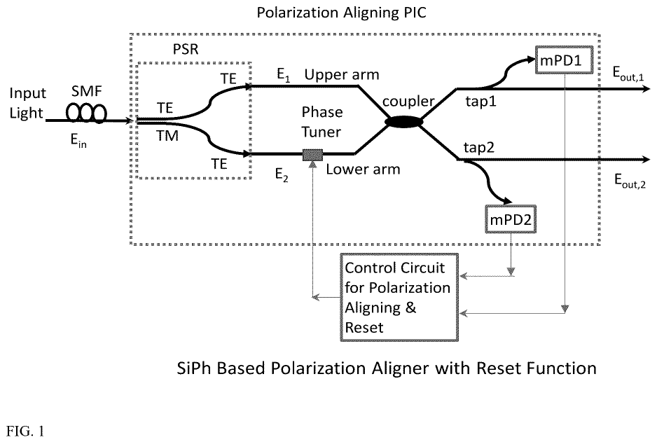

FIG. 1 shows one embodiment of silicon photonic (SiPh) based polarization aligner with reset function, which consists of an input port, a polarization aligning photonic integrated chip (PIC), and two output ports, and a control circuit with reset function for polarization aligning. A light from a single mode fiber (SMF) with arbitrary polarization state is launched into the input port of the polarization aligning PIC, which is then split into two portions of lights by a polarization splitter and rotator (PSR). The first portion has transverse electric (TE) polarization with optical filed expressed as E₁, and the second portion has transverse magnetic (TM) polarization which is then rotated 90 degrees inside PSR to make it also have TE polarization, with optical filed expressed as E₂. E₁ is input into the upper arm waveguide, and E₂ is input into the lower arm waveguide, which passes through a phase tuner. Then the two lights E₁ and E₂ are combined by a 2×2 50:50 optical coupler. The upper port output of the optical coupler is input into a first optical tap (tap1), with a small portion of light launched into a first monitor photodetector (mPD1), and the majority of the light becomes the first output light (E_{out,1}) of the polarization aligner. The lower port output of the optical coupler is input into a second optical tap (tap2), with a small portion of light launched into a second monitoring photodetector (mPD2), and the majority of the light becomes the second output light (E_{out,2}) of the polarization aligner. The mPD1 and mPD2 are connected to the control circuit which operates polarization aligning and reset. The control circuit may first amplify the photocurrents of mPD1 and mPD2 by transimpedance amplifiers (TIA) and convert the amplified analog signals to digital signals by two analog-to-digital converters (ADC) before using them for signal processing and algorithm operation of polarization tracking and reset.

The polarization alignment is detailed next. Once the polarization state of input light has an orientation angle θ relative to the TE polarization of the aligner, the input light will be split into the upper arm with optical field E₁ and lower arm with optical field E₂, which are then combined by the optical coupler to generate the two output lights E_{out,1} and E_{out,2}. The power of the two output lights are dependent on the input polarization orientation angle θ and the relative phase φ between E₁ and E₂. The relative phase φ between upper arm and lower arm can be adjusted by the phase tuner which may be a heater. For a given θ, we can adjust φ to make the power of two output lights equal. The control circuit receives the dynamic bandwidth allocation (DBA) information from a master or an optical line terminal (OLT) to know which time slots have no transmitting traffics. It triggers the reset process once the heater current is close to the pre-determined limit in a time slot when there is no transmitting traffic. It resets the heater current to a new value which introduces a 2Nπ phase jump for heater generated phase shift between the two arms, where N is a positive integer number.

One design of the polarization aligning system includes:
A polarization splitter and rotator (PSR), connected to an incoming single mode fiber
A phase tuner, connected to the PSR
A 2×2 optical coupler, with the first input port connected to PSR and second input port connected to the phase tuner
A first optical tap (tap1), connected to the optical coupler, and majority portion output port becomes the first output port of polarization aligner; A second optical tap (tap2), connected to the optical coupler, and the majority portion output port becomes the second output port of polarization aligner
A first monitoring photodetector (mPD1), connected to tap1; A second monitor photodetector (mPD2) connected to tap2
A control unit which:
   is connected to mPD1 and mPD2 to receive electrical signals
   is connected to the phase tuner to apply current, where the phase tuner may be a heater
   has an algorithm operation function for polarization aligning
   has a reset function to reset the heater current to a designated value in selected time slots when the current is close to pre-determined limit

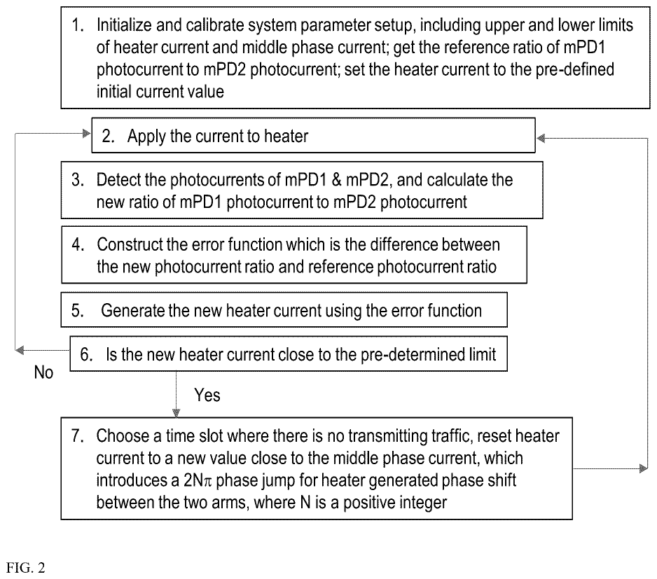

The algorithm for the polarization alignment which generates equal power for the two output lights is shown in the flowchart of FIG. 2. First, the process may initialize or calibrate the heater current and mPD photocurrents when there is no polarization variation in the input light. The heater generated phase shift φ between the two arms (normalized to π) is defined in Equ. (1), to first order approximation:

$$φ = {I}_{htr}^{2} {R}_{htr} / {P}_{π} \qquad ( 1 )$$

Here Iₕₜᵣ is the heater current, Rₕₜᵣ is the heater resistance, and P_{π} is the heater power required to generate 1π phase shift.

The upper limit current I_{htr,up} and lower limit current I_{htr,low} of the heater are defined to set the operation range [I_{htr,low}, I_{htr,up}]; A typical heater current range is to provide a few π phase shift. For example, the current range is set to make phase shift in the range of [π, 5π], with up limit phase of 5π, low limit phase of π, and middle phase of 3π. In some cases, the phase shift range can be bigger to facilitate the tracking, but with higher power consumption. The initial heater current for polarization aligning is then set up. In principle, it can be a random number within the range between I_{htr,low} and I_{htr,up} A useful or typical number of initial heater current could be the middle phase current:

$${l}_{htr , midPh} = \sqrt{( {l}_{htr , low}^{2} + {l}_{htr , up}^{2} ) / 2} \qquad ( 2 )$$

where the heater current generates phase shift at the middle of phase shift range.

To reduce the number of iterations for faster convergence, the current applied to the heater can be first scanned to identify the rough bias current corresponding to the quad point via measuring the mPD1 or mPD2 photocurrent, which is done with a stable input polarization. The transmission quad point corresponds to where the two outputs have equal powers. We scan the heater current in the operation range, record the photocurrent of mPD1, then locate the heater current when the photocurrent curve is at the transmission quad point: I_{htr_Q_ini}; Set the heater current Iₕₜᵣ to I_{htr_Q_ini}, record the corresponding photocurrent of mPD1, i_{mPD1_Q_ini}, and record the photocurrent of mPD2, i_{mPD2_Q_ini}.

The process calculates the reference photocurrent ratio using the following equation:

$${R}_{R e f} = {i}_{mPD1 \_ Q \_ ini} / {i}_{mPD 2\_ Q \_ ini} \qquad ( 3 )$$

Then the tracking system is applied to track and align polarization where input polarization is random or undefined. The tracking algorithm is described as following: For each control loop with loop index k, a heater bias current, I_{htr,k} is generated by the control circuit and applied to heater as step 2 in FIG. 2, the heater will introduce a phase shift between the two arms of the polarization aligner. This phase shift together with input light polarization orientation angle will change the power allocation between the two output lights, which are detected in the two mPD photocurrents: i_{mPD1} and i_{mPD2}, as shown in step 3 of FIG. 2. Then the new photocurrent ratio is calculated using the following equation:

$$R = {i}_{m P D 1} / {i}_{m P D 2} \qquad ( 4 )$$

The error function is constructed in step 4 via Equ. (5), which is the difference between the new photocurrent ratio and reference photocurrent ratio, normalized by reference photocurrent ratio:

$$Err = ( R - {R}_{R e f} ) / {R}_{R e f} \qquad ( 5 )$$

The error function is used to calculate the new heater current for next loop:

$${I}_{htr , k + 1} = {I}_{htr , k} + ρ \times E r r \qquad ( 6 )$$

where ρ is the loop control scaling factor, which is dependent on the polarization aligner input optical power, insertion loss, mPD responsivity, and gain of TIA, etc. The sign of ρ determines if the polarization aligning is at π/4 quad or 3π/4 quad of the transfer function.

Then the algorithm will check if the new heater current I_{htr,k+1} is close to the current limit, as shown in step 6 of FIG. 2. Step 7 defines how the heater current changes once it is close to the pre-determined limit.

If the heater current is close to the upper limit, it chooses a time slot where there is no transmitting traffic and resets the current I_{htr,k+1} to a new value close to the middle phase current, which introduces a 2Nπ phase reduction in phase shift between the two arms, as expressed in Equ. (7)

$${I}_{htr , k + 1} = \sqrt{( φ - 2 N ) {P}_{π} / {R}_{htr}} \qquad ( 7 )$$

where N is a positive integer.

If the heater current is close to the lower limit, the algorithm chooses a time slot where there is no transmitting traffic, and resets the current I_{htr,k+1} to a new value close to the middle phase current, which introduces a 2Nπ phase increase in the phase shift between the two arms, as expressed in Equ. (8)

$${I}_{htr , k + 1} = \sqrt{( φ + 2 N ) {P}_{π} / {R}_{htr}} \qquad ( 8 )$$

In equations (7) and (8), N=1 for typical or most scenarios. But for a large heater current operation range, N could be greater than 1.

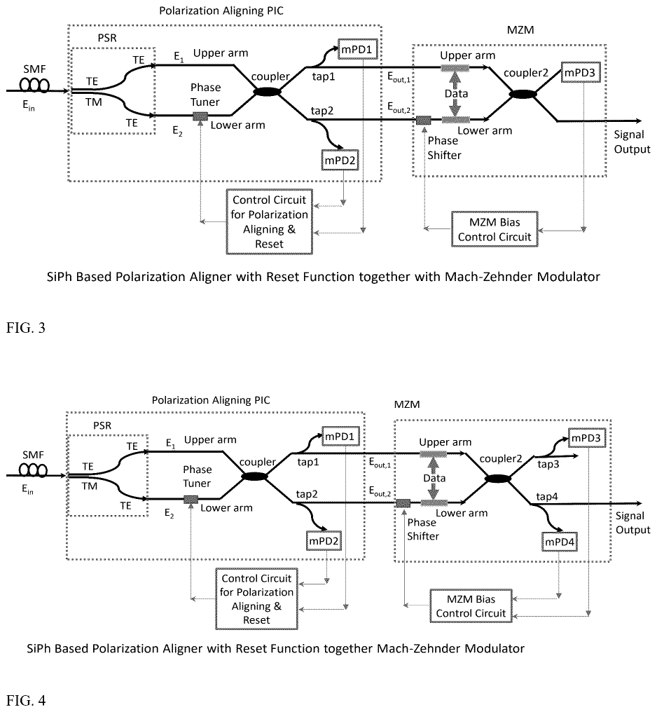

FIG. 3 shows an embodiment of proposed polarization aligner with reset function together with Mach-Zehnder modulator. The polarization aligner with reset function can be integrated together with a Mach-Zehnder modulator (MZM) as shown in FIG. 3. The two output lights of the polarization aligner are launched into the upper arm and lower arm of the MZM, respectively, both were modulated by high-speed data which may be from an ECU in a vehicle. Another phase shifter is located in the lower arm to adjust the relative phase between the two arms of the MZM. The two modulated lights are combined by another optical coupler (coupler2) to generate two complementary outputs. The upper port output is sent into a monitoring PD (mPD3). An attenuator (or splitter) may be introduced between coupler2 and mPD3 to reduce the optical power into mPD3 to relieve the mPD saturation. The lower port output becomes the output signal of the MZM. An MZM bias control circuit receives mPD3 output, carries out MZM bias control algorithm and sends control current to the MZM heater to adjust the phase of the phase shifter, as shown in FIG. 3.

In FIG. 3, only one monitoring PD (mPD3) is used for MZM bias control. Dither generation and detection may be required in control algorithm for this configuration. Two mPDs may be used for MZM bias control, which does not require dither generation and detection in control algorithm, as shown in FIG. 4. The upper port of coupler2 output is connected to an optical tap (tap3), a small portion of tap3 output is sent into a monitoring PD (mPD3) while the majority portion of tap3 output is terminated. The lower port of the coupler2 output is connected to another optical tap (tap4), a small portion of tap4 output is sent into another monitoring PD (mPD4) while the majority portion of tap4 output becomes the output signal of MZM. An MZM bias control circuit receives mPD3 output and mPD4 output, carry out MZM bias control algorithm and send control current to the MZM heater to adjust the phase of the phase shifter, as shown in FIG. 4.

One process to adjust the phase of the phase shifter for polarization aligning includes the following:
Receiving an input light with undefined polarization
Splitting the input light into a first light and a second light, with the second light being rotated to have the same polarization as the first light
Tuning the phase of the second light
Combing the first light and second light and outputting a first output light and second output light
Tapping a small portion of first output light to mPD1; Tapping a small portion of second output light to mPD2
Providing a control unit:
   to receive the output of mPD1 and the output of mPD2
   to carry out the algorithm for polarization aligning
   to generate a calculated heater current and apply to the phase tuner
   to reset the heater current to a new designated value in selected time slots when it is close to the pre-determined limit

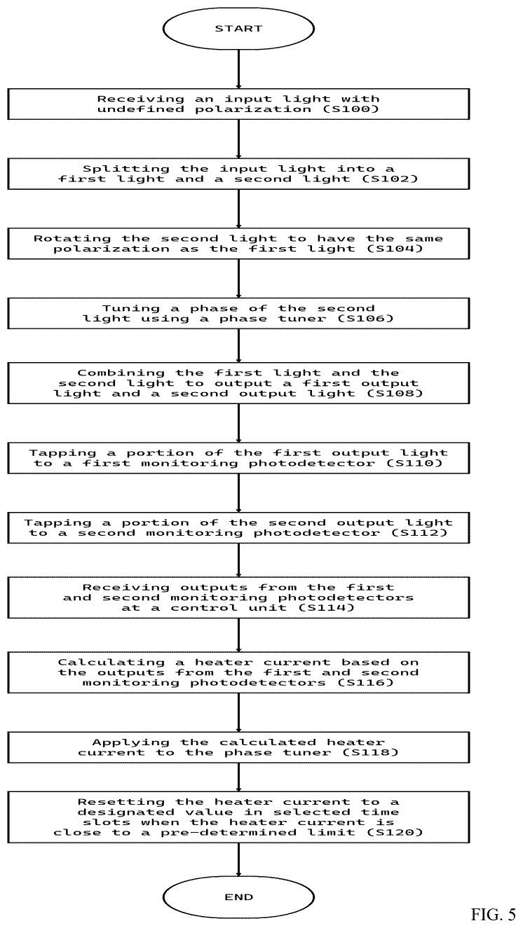

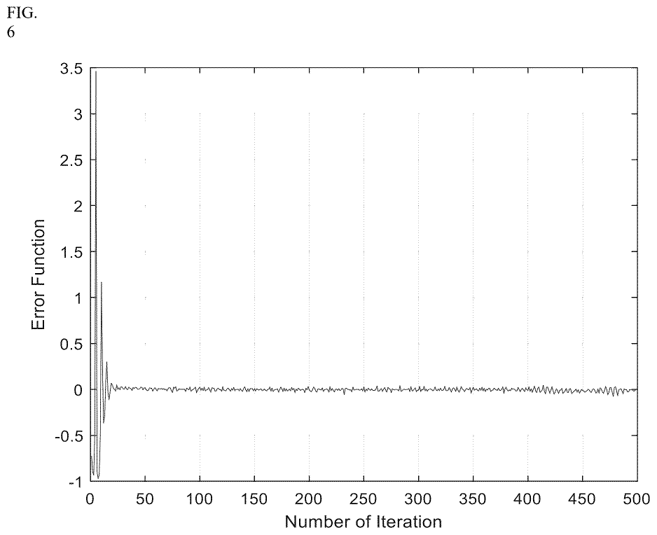

FIG. 5 shows the flowchart with steps for processing input light using phase tuning and heater current reset methods. The method commences with receiving an input optical signal that exhibits an undefined polarization state. In this aspect, the signal enters the system without any predetermined polarization orientation, which is critical because numerous optical components require a well-defined polarization for optimal performance. The input signal can inherently vary in its polarization properties due to characteristics of its source or environmental influences. In embodiments of one implementation, this step is implemented such that the system is capable of accommodating optical signals regardless of their initial polarization, thereby providing flexibility and robustness in handling diverse optical streams. This initial reception of an input optical signal with undefined polarization, as represented by S100, establishes the foundation for subsequent polarization alignment steps within the system.

In one embodiment, an input beam with an undefined polarization is first received and then divided into two distinct paths. Operation S102 splits the incoming beam into a first path and a second path. This separation is fundamental because it allows the subsequent independent adjustment of each path's polarization state. By partitioning the incoming beam, the system can later rotate the polarization of the second path to align with that of the first and further tune its phase. This sequence of operations promotes greater polarization alignment, ensuring optimized signal fidelity and reduced loss resulting from polarization mismatches.

In one embodiment, the second beam undergoes a rotation operation to align its polarization with that of the first beam. Reference numeral S104 designates this operation, during which the polarization direction of the second beam is modified to match the polarization orientation of the first beam. This rotation is essential in ensuring that both transmission paths operate with matched polarization parameters, thereby facilitating coherent combination and minimizing losses associated with polarization mismatches.

The phase tuning unit, designated as S106, is configured to adjust the phase of the second beam after it has been rotated to align with the polarization of the first beam. This component actively modifies the phase of the second beam to ensure optimal interference and effective recombination with the first beam. In some embodiments, the phase tuner operates under the control of an algorithm that receives monitoring feedback from associated photodetectors. The adjustment process compensates for any phase mismatches that could be introduced during the splitting and polarization rotation stages, thereby ensuring that the second beam maintains phase alignment that is conducive to superior signal fidelity when combined with the first beam.

The element designated S108 merges the first and second electromagnetic beams to yield two distinct output beams. In this process, the two beams—with the second having been rotated and phase-tuned for polarization matching—are combined, resulting in the formation of both a first and a second output beam. This merging is performed within an optical coupler that facilitates the coherent mixing of the beams, ensuring that the outputs maintain the desired polarization alignment for subsequent processing in the system.

A portion of the first output beam is tapped and directed to a first monitoring photodetector. In this context, tapping a portion of the first output beam to the first monitoring photodetector (S110) entails diverting a representative fraction of the optical emission via an optical tap so that the photodetector receives it and converts the optical signal into an electrical signal. This electrical signal reflects the performance of the first output beam and is provided as feedback to a control unit. The control unit, upon receiving signals from both the first and second monitoring photodetectors, executes an algorithm for polarization alignment that calculates a heater current. The calculated current is then applied to the phase tuner to maintain proper phase and polarization alignment, with the heater current being reset to a designated value during selected time slots when it nears a predetermined limit.

The precise determination of the heater current plays an essential role in the system's polarization alignment process. By utilizing outputs from the monitoring photodetectors, the control unit computes the appropriate current value to correct any deviation from the desired polarization state. This approach ensures that applying the current to the phase tuner preserves the polarization of the optical beam in a manner that minimizes losses and enhances signal fidelity.

When the heater current nears a pre-determined limit, the control unit initiates a process wherein, during selected time slots, the heater current is automatically reset to a designated value (S120). This resetting process ensures that the heater current does not exceed its operational range, thereby maintaining stable phase tuning while preventing potential overdriving, and ultimately assuring continuous alignment of the polarizations.

In one embodiment, the heater current is continuously monitored and regulated to ensure stable operation of the optical system. When the heater current is observed to approach a predetermined threshold, a reset operation is initiated. This reset operation involves setting the heater current to a new value that is close to a mid-range phase current. The mid-range phase current represents a nominal operational value within the dynamic range of the phase tuner, which is optimal for consistent phase adjustment performance. By reinitializing the heater current toward this mid-range phase level, the system avoids extended operation at extreme values that could lead to instability or premature drift in phase tuning. The control unit, upon detecting that the heater current is near its limit, calculates an appropriate new value near the mid-range phase current and adjusts the applied current accordingly. This technique ensures that the phase tuner functions effectively within its optimal regime, thereby maintaining the required phase relationship between the first optical beam and the second optical beam with minimal deviations. The resetting process is executed during preselected time slots to minimize any disruption to the overall operation of the optical apparatus. This method of resetting the heater current to a value near a mid-range phase current allows for continuous self-adjustment and stabilization of the output characteristics, thereby enhancing the longevity and reliability of the optical system.

In one embodiment, after the combining step generates a first output beam and a second output beam, the optical system further connects the first output beam to a first branch of a Mach-Zehnder modulator and the second output beam to a second branch of the Mach-Zehnder modulator. In this configuration, the first branch is designed to receive the first output while the second branch is configured to receive the second output. By directing the two beam paths into separate branches of the modulator, the system enables controlled interference among the optical signals when the modulator applies appropriate electrical modulation signals to each branch. This interference effect permits modulation of the composite output based on relative phase and amplitude differences induced within each branch. The arrangement allows for precise control of the modulation process, yielding an output beam whose optical characteristics, such as intensity and/or phase, are modulated in accordance with the electrical signals applied to the Mach-Zehnder modulator. Variations of this embodiment can incorporate adjustments to the splitting ratio and polarization of the input beam to ensure optimal signal balance between the first and second branches, thereby enhancing the modulator's performance and output stability.

At S108, the first optical signal and the second optical signal are combined using a 2×2 optical coupler. In one embodiment, the 2×2 optical coupler is configured to accept as its inputs the first optical signal and the phase-tuned second optical signal, and to deliver as its outputs the first output optical signal and the second output optical signal. The 2×2 optical coupler comprises a coupling region in which the first and second signals are brought into close proximity so that an evanescent field from one waveguide overlaps with that from the other. This overlap facilitates power transfer between the waveguides, resulting in a controlled mixing of the two input optical signals. The coupling ratio of the optical coupler is engineered to achieve a desired balance between the first and second signals such that the relative intensities of the first output signal and the second output signal are optimized for subsequent operations. In some embodiments, the optical coupler is integrated onto a photonic integrated circuit and formed using materials such as silicon, indium phosphide, or silicon nitride. The design of the coupler is adjusted to minimize insertion losses and to provide exceptional repeatability and reliability in combining the optical signals. The performance of the optical coupler is further characterized by its phase response, which plays an essential role in determining the interference conditions between the combined optical signals. Thus, by employing the 2×2 optical coupler, the system effectively combines the two optical signals into controlled output beams, whose properties are subsequently monitored by the first and second monitoring photodetectors at S110 and S112, respectively.

The control unit computes a heater current using outputs from the first and second monitoring photodetectors at S116 and then applies the computed current to the phase tuner at S118 to achieve optimal phase tuning. Additionally, a process is implemented in which a photocurrent ratio is determined from the outputs monitored by the first and second photodetectors. A reference photocurrent ratio is maintained, and a new photocurrent ratio is measured upon updating the tapped outputs. An error function is generated based on the difference between the new photocurrent ratio and the reference photocurrent ratio. This error function is then used to calculate the heater current for the next iteration, thus establishing a feedback mechanism to refine the phase tuning via the phase tuner. Moreover, at S120, the heater current is reset to a new value within selected time slots when it nears a predetermined limit, thereby preventing operation beyond acceptable boundaries.

The iterative process, which includes recalculating the error function based on the updated photocurrent ratio and using it to determine the heater current for the subsequent iteration, enables the optical system to continuously adjust to variations in the photocurrent characteristics. As a consequence, the system optimizes the phase control of the combined optical beam and maintains more precise control over the output optical properties while ensuring that the heater current remains within permissible limits. Variations and modifications to these embodiments can be implemented without departing from the spirit and scope of one implementation.

A polarization alignment system is provided that processes an input optical signal possessing an undefined polarization state to generate output optical signals with controlled polarization characteristics. In one embodiment, the system comprises a polarization splitter and rotator (PSR) configured to receive the input optical signal and divide it into a first beam and a second beam. The PSR is designed not only to perform the splitting function but also to rotate one of the divided beams into a predetermined polarization state that is compatible with the other beam. Connected downstream from the PSR, a phase tuner is configured to adjust the phase of the second beam. The phase tuning mechanism can be implemented using various phase control technologies, allowing for precise adjustment of the phase difference between the two beams.

A 2×2 optical coupler is operatively connected to both the PSR and the phase tuner. This coupler is arranged to merge a first beam with a phase-tuned second beam to produce a first output beam and a second output beam. Its configuration ensures that the relative phase and intensity of these output beams are suitable for subsequent monitoring and alignment operations. To assess the properties of the output beams, the system incorporates a first optical tap and a second optical tap. The first tap diverts a portion of the first output beam to a first monitoring photodetector (mPD1), while the second tap extracts a portion of the second output beam and directs it to a second monitoring photodetector (mPD2). These optical taps and their associated photodetectors facilitate real-time monitoring of parameters such as power levels and phase-related characteristics.

A control unit is incorporated into the system and electrically connected to both the monitoring photodetectors and the phase tuner. The control unit is arranged to receive electrical signals corresponding to the optical signals captured by mPD1 and mPD2. Based on these signals, it executes an algorithm for polarization alignment that includes processing the detected optical power levels, evaluating the phase difference between the output channels, and determining adjustments necessary to achieve optimum polarization alignment. In the alignment process, the control unit calculates a current value to be applied to the phase tuner to modify the phase of the second optical beam, thus improving the polarization state of the combined output beams. Moreover, the control unit is programmed to monitor the applied current and, when the current approaches a predetermined limit, to reset the current to a new value during selected time slots. This reset function is implemented as a safeguard to prevent the current from exceeding operational limits and to ensure stable and reliable extended duration operation of the polarization alignment system.

In the described embodiment, the integration of the PSR, phase tuner, optical coupler, optical taps, monitoring photodetectors, and control unit enables the polarization alignment system to continuously adapt and maintain optimal output signal characteristics. The coordinated operation of these components ensures that the system can reliably correct deviations in polarization states caused by input variability or environmental changes, thereby enhancing the stability and functionality of optical transmission or processing systems in which the polarization alignment system is employed.

In one embodiment, the phase tuner is implemented as a heater element configured to adjust the phase of a second optical signal. In this embodiment, the phase tuner comprises a resistive heater that, when supplied with a heater current, produces a localized temperature change that alters the refractive index of an associated optical waveguide. The modification in refractive index induces a phase shift in the second optical signal propagating through the phase tuner. The heater may be fabricated from materials such as titanium, platinum, or other suitable metals, which provide the necessary resistivity and thermal characteristics. The control unit calculates the heater current based on inputs from the monitoring photodetectors and directs the calculated current to the resistive heater. As the heater current flows, the temperature increase generated by the heater changes the optical path length of the second optical signal, effectively tuning its phase with respect to the first optical signal. This phase adjustment is essential for achieving the desired interference conditions when the first and second optical signals are subsequently combined to generate the output signals.

In one embodiment, the apparatus further comprises amplifiers and analog-to-digital converters operatively coupled to the outputs of the first and second monitoring photodetectors. In this configuration, the electrical signals generated by the tapped portions of the first and second output optical beams, which are received at mPD1 and mPD2 respectively, are initially delivered to the designated amplifiers. These amplifiers boost the signal levels to ensure they possess sufficient strength and to minimize the impact of ambient noise. After amplification, the signals are routed into analog-to-digital converters that transform the analog electrical signals into digital signals. The resulting digital signals are then provided to the control unit, which processes them for subsequent operations, such as calculating the appropriate heater current. Converting the photodetector outputs from analog to digital before their reception by the control unit improves the accuracy and reliability of the control processes, including the adjustment of the phase of the second output optical beam and the resetting of the heater current when necessary. The digital representation enables the control unit to execute more precise and noise-resistant computations when determining adjustments at S116 and applying the calculated heater current at S118.

In one embodiment, after receiving the outputs from the first and second monitoring photodetectors at S114, the control unit is further configured to calculate an error function based on the difference between a new photocurrent ratio and a reference photocurrent ratio. The new photocurrent ratio is determined by comparing the monitored outputs from the first and second photodetectors, which represent the intensity levels of tapped portions of the first and second output signals, respectively. This ratio is compared to a predetermined reference photocurrent ratio that corresponds to a desired or optimal operating condition for the optical apparatus. The calculated error function quantifies the deviation between the measured photocurrent ratio and the reference condition. The control unit then utilizes this error function to adjust operational parameters, such as the heater current, to compensate for any deviation; thereby ensuring that the optical system maintains its intended performance characteristics. The process of calculating the error function and subsequently incorporating it into the control loop allows for dynamic, real-time correction of the photocurrent ratio, providing enhanced stability and precision of the output signal characteristics.

In addition to the foregoing features, the apparatus further comprises an attenuator connected between the optical coupler and at least one of the monitoring photodetectors. In certain embodiments, the attenuator is located between the output port of the optical coupler and the first monitoring photodetector. The attenuator functions to reduce the optical power incident on the monitoring photodetector, thereby preventing potential saturation. The attenuator includes any suitable optical power reduction device, such as a fixed or variable neutral density filter or other beam intensity reduction element. By incorporating the attenuator in the optical path, the system ensures that the photodetectors operate within their optimal dynamic range, providing reliable and accurate monitoring signals used for determining the proper heater current.

Experimentation was carried out to verify the proposed scheme shown in FIG. 1. A SiPh based polarization aligner PIC was manufactured, where a heater with P_{π} around 23 mW and heater resistance Rₕₜᵣ around 150 Ohm was fabricated as the phase tuner. The outputs of mPD1 and mPD2 were amplified by corresponding TIAs and AD converted into digital signals by a National Instrument Data Acquisition System (DAQ), before being sent to a desktop for digital signal processing of algorithm operation using Matlab. The newly generated heater current was sent to set a Keithley Source Meter (2400) which was then applied to the heater of the polarization aligner. An Agilent polarization scrambler (11896A) was used to vary the polarization state of input light.

The control algorithm was verified to be working. FIG. 5 shows the tested error function as a function of iteration number. The initial heater current was set to a random number, and the polarization scrambler was turned on from the beginning. FIG. 5 shows that the polarization aligner converged after the first 20 iterations and then stabilized during the polarization aligning test. The iteration number required for convergence depends on the heater response time, input polarization rotation speed, and loop control scaling factor, etc. Some small variation in the error function after convergence is partially due to the noise in the control system.

The use of the term “about” means a range including ±10% of the subsequent number, unless otherwise stated. While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

1. A method for aligning polarization of an input light, comprising:
receiving the input light with undefined polarization;
splitting the input light into a first light and a second light;
rotating the second light to have the same polarization as the first light;
tuning a phase of the second light using a phase tuner;
combining the first light and the second light to output a first output light and a second output light;
tapping a portion of the first output light to a first monitoring photodetector;
tapping a portion of the second output light to a second monitoring photodetector;
receiving outputs from the first and second monitoring photodetectors at a control unit;
calculating a heater current based on the outputs from the first and second monitoring photodetectors;
applying the calculated heater current to the phase tuner;
resetting the heater current to a calculated value in selected time slots when the heater current is close to a pre-determined limit.

2. The method of claim 1, wherein the phase tuner is a heater.

3. The method of claim 1, further comprising amplifying and analog-to-digital converting the outputs from the first and second monitoring photodetectors before receiving them at the control unit.

4. The method of claim 1, wherein resetting the heater current comprises resetting to a new value close to a middle phase current.

5. The method of claim 4, wherein the new value introduces a 2Nπ phase jump for heater generated phase shift between two arms of a polarization aligner, where N is a positive integer.

6. The method of claim 1, wherein the selected time slots for resetting the heater current are chosen when there is no transmitting traffic.

7. The method of claim 1, further comprising connecting the first output light to an upper arm of a Mach-Zehnder modulator and connecting the second output light to a lower arm of the Mach-Zehnder modulator.

8. The method of claim 1, wherein splitting the input light is performed using a polarization splitter and rotator (PSR).

9. The method of claim 1, wherein combining the first light and the second light is performed using a 2×2 optical coupler.

10. The method of claim 1, further comprising calculating an error function based on a difference between a new photocurrent ratio and a reference photocurrent ratio, and using the error function to calculate the heater current for the next iteration.

11. A polarization alignment system, comprising:
a polarization splitter and rotator (PSR) configured to receive an input light with undefined polarization and split it into a first light and a second light;
a phase tuner connected to the PSR and configured to tune a phase of the second light;
a 2×2 optical coupler connected to the PSR and the phase tuner, configured to combine the first light and the second light to output a first output light and a second output light;
a first optical tap connected to the optical coupler to tap a portion of the first output light;
a second optical tap connected to the optical coupler to tap a portion of the second output light;
a first monitoring photodetector (mPD1) connected to the first optical tap;
a second monitoring photodetector (mPD2) connected to the second optical tap; and
a control unit connected to mPD1, mPD2, and the phase tuner, configured to:
receive electrical signals from mPD1 and mPD2;
execute an algorithm for polarization alignment;
calculate and apply a current to the phase tuner, and;
reset the current to a calculated (seems this is a better wording?) value in selected time slots when the current is close to a pre-determined limit.

12. The system of claim 11, wherein the phase tuner is a heater.

13. The system of claim 11, further comprising amplifiers and analog-to-digital converters to amplify and convert the electrical signals from mPD1 and mPD2 to digital signals before they are received by the control unit.

14. The system of claim 11, wherein the first output light is connected to an upper arm of a Mach-Zehnder modulator and the second output light is connected to a lower arm of the Mach-Zehnder modulator.

15. The system of claim 11, wherein the control unit is configured to reset the current to a new value close to a middle phase current.

16. The system of claim 11, wherein the selected time slots for resetting the current are chosen when there is no transmitting traffic.

17. The system of claim 11, wherein the control unit is further configured to calculate an error function based on a difference between a new photocurrent ratio and a reference photocurrent ratio.

18. The system of claim 11, further comprising an attenuator connected between the optical coupler and at least one of the monitoring photodetectors to reduce optical power and prevent photodetector saturation.

19. The system of claim 11, wherein a first output port of polarization aligner is connected to an upper arm of a Mach-Zehnder modulator, the second output port of polarization aligner is connected to lower arm of a Mach-Zehnder modulator.

20. A method for aligning polarization of an input light, comprising:
receiving the input light with undefined polarization;
splitting the input light into a first light and a second light, with the second light being rotated to have the same polarization as the first light tuning the phase of the second light combing the first light and second light and outputting a first output light and second output light;
tapping a predetermined portion of first output light to a first monitoring photodetector (mPD1), and tapping a predetermined portion of second output light to a second monitoring photodetector (mPD2); and
controlling a processor to:
receive the output of mPD1 and the output of mPD2;
perform polarization aligning;
generate a calculated heater current and apply to the phase tuner; and
reset the heater current to a new designated value in selected time slots when it is close to the pre-determined limit.
